(19) United States
(12) Patent Application Publication
(10) Pub. No.: US 2025/0279537 A1
(43) Pub. Date: Sep. 4, 2025

(54) ELECTRICITY-DRIVEN VEHICLE

(71) Applicants: TOYOTA JIDOSHA KABUSHIKI KAISHA, Aichi-ken (JP); ISUZU MOTORS LIMITED, Kanagawa (JP)

(72) Inventors: Masayoshi WATANABE, Nagoya-shi (JP); Kan SAITO, Ikeda-shi (JP); Toshiya TSUJITA, Ikeda-shi (JP); Naohiro NAKAMURA, Ikeda-shi (JP); Yasuo KAWAMOTO, Ikeda-shi (JP); Hideki OGAMI, Ikeda-shi (JP)

(21) Appl. No.: 19/062,073

(22) Filed: Feb. 25, 2025

(30) Foreign Application Priority Data
Feb. 29, 2024 (JP) 2024-029866

(51) Int. Cl. H01M 50/358; B60K 1/04; H01M 10/658; H01M 50/249; H01M 50/317

(52) U.S. Cl. CPC H01M 50/358; B60K 1/04; H01M 10/658; H01M 50/249; H01M 50/317; B60K 2001/0438

(57) ABSTRACT

An electricity-driven vehicle includes: a floor panel; a depressed portion of a groove shape, that is formed on the floor panel and that extends in a vehicle width direction; a battery casing that is placed in the depressed portion; one or more batteries of a replaceable type, that can be attached to and detached from the battery casing; a smoke exhaust duct that extends from the battery casing, that penetrates through a bottom surface of the depressed portion, and that is opened to an outside of the vehicle; and a check valve that is provided on the smoke exhaust duct, and that prohibits inflow of a fluid from the outside of the vehicle into the battery casing.

### CROSS REFERENCE TO RELATED APPLICATION

This application claims priority to Japanese Patent Application No. 2024-029866 filed on Feb. 29, 2024, which is incorporated herein by reference in its entirety including the specification, claims, drawings, and abstract.

### TECHNICAL FIELD

The present disclosure relates to an electricity-driven vehicle, equipped with a replaceable battery.

### BACKGROUND

In the related art, an electricity-driven vehicle is widely known, in which a motor which is a motive power source, and a battery which supplies electric power to the motor are provided on a vehicle. The battery equipped in the electricity-driven vehicle is a secondary battery which can be charged and discharged, and is charged by an external power source as necessary.

A configuration is being proposed which employs a replaceable battery, which can be attached to and detached from the electricity-driven vehicle, in order to effectively utilize the electricity-driven vehicle even during charging of the battery. In a structure with a replaceable battery, when a state of charge of the battery equipped on the electricity-driven vehicle becomes low, the battery is removed from the electricity-driven vehicle, and is replaced with another battery which is charged in advance. The battery which is removed from the electricity-driven vehicle is then charged outside the electricity-driven vehicle. Because the electricity-driven vehicle can travel even during the charging of the removed battery, the electricity-driven vehicle can be more effectively utilized.

In such a secondary battery, it is known that gas is generated due to internal short-circuiting, external short-circuiting, or the like. JP 2017-091824 A discloses a battery unit having a release passage through which such gas flows. According to the technique of JP 2017-091824 A, the gas generated from the battery is guided to the outside of a casing of the battery unit, without remaining in the casing.

When the battery is to be placed in a space which is not completely separated from a vehicle cabin, a structure is demanded which prevents inflow of the gas into the vehicle cabin. However, J P 2017-091824 A does not consider processing of gas guided to the outside of the casing.

An advantage of the present disclosure lies in an electricity-driven vehicle which can prevent inflow of gas generated from a battery into a vehicle cabin.

### SUMMARY

According to one aspect of the present disclosure, there is provided an electricity-driven vehicle comprising: a floor panel; a depressed portion of a groove shape, that is formed on the floor panel and that extends in a vehicle width direction; a battery casing that is placed in the depressed portion; one or more batteries of a replaceable type, that can be attached to and detached from the battery casing; a smoke exhaust duct that extends from the battery casing, that penetrates through a bottom surface of the depressed portion, and that is opened to an outside of the vehicle; and a check valve that is provided on the smoke exhaust duct, and that prohibits inflow of a fluid from the outside of the vehicle into the battery casing.

With the above-described structure, the gas generated in the battery can be released to the outside of the vehicle through the smoke exhaust duct. As a result, the inflow of the gas generated from the battery into the vehicle cabin can be prevented.

In this case, the electricity-driven vehicle may further comprise a deck board that covers and hides the depressed portion; and a thermal insulation member placed between the deck board and the battery casing.

With the above-described structure, transfer of heat generated in the battery to an upper space of the deck board can be prevented. As a result, degradation of baggage placed in the vehicle cabin, and discomfort of passengers in the vehicle cabin can be reduced.

Further, a loading port of the battery may be formed at one end of the battery casing in the vehicle width direction, and the smoke exhaust duct may extend from an end surface of the battery casing at a side opposite the loading port.

With the above-described structure, a terminating end of the smoke exhaust duct is not hidden by the battery casing. Thus, an operator can assemble the battery casing while visually checking the position of the terminating end of the smoke exhaust duct. As a result, the assembling process of the battery casing can be simplified.

The smoke exhaust duct may penetrate through the bottom surface of the depressed portion approximately at a center in the vehicle width direction.

With the above-described structure, even when the battery casing is placed with left and right sides inverted, the position of the hole through which the smoke exhaust duct penetrates does not need to be changed.

The smoke exhaust duct may extend from a bottom surface or a vehicle-rear-end surface of the battery casing.

By providing the smoke exhaust duct at the bottom surface of the battery casing, a dimension of the battery casing in the vehicle width direction other than the smoke exhaust duct can be increased. Further, by providing the smoke exhaust duct at the vehicle-rear-end surface of the battery casing, the smoke exhaust duct can be separated from the front seat (and, consequently, the passengers).

According to an aspect of the present disclosure, inflow of gas generated from the battery into the vehicle cabin can be prevented.

### BRIEF DESCRIPTION OF DRAWINGS

Embodiment(s) of the present disclosure will be described based on the following figures, wherein:

FIG. 1 is a perspective diagram showing a region near a rear side door of an electricity-driven vehicle, viewed from outside the vehicle;

FIG. 2 is a schematic plan view of the electricity-driven vehicle;

FIG. 3 is a cross-sectional diagram along an A-A line of FIG. 2;

FIG. 4 is a cross-sectional diagram along a B-B line of FIG. 2;

FIG. 5 is a diagram showing another example placement of a smoke exhaust duct; and

FIG. 6 is a diagram showing yet another example placement of the smoke exhaust duct.

### DESCRIPTION OF EMBODIMENTS

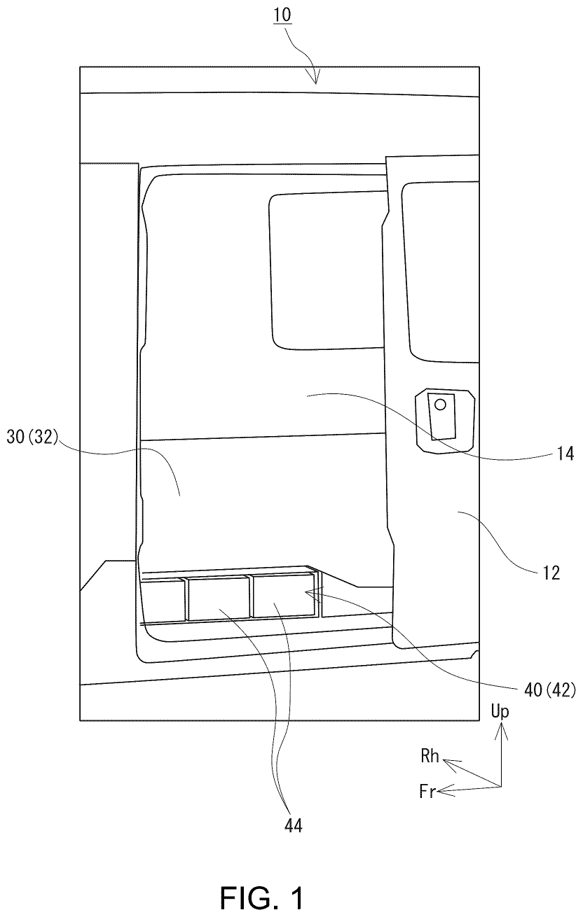

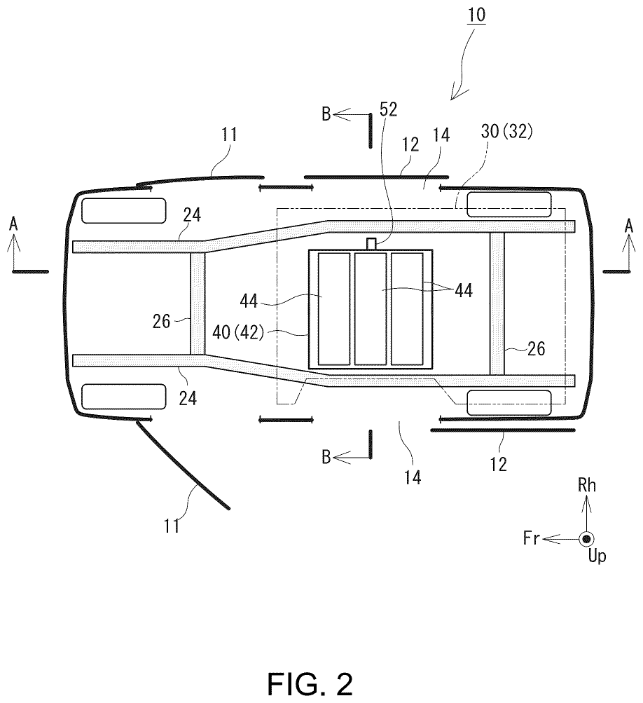

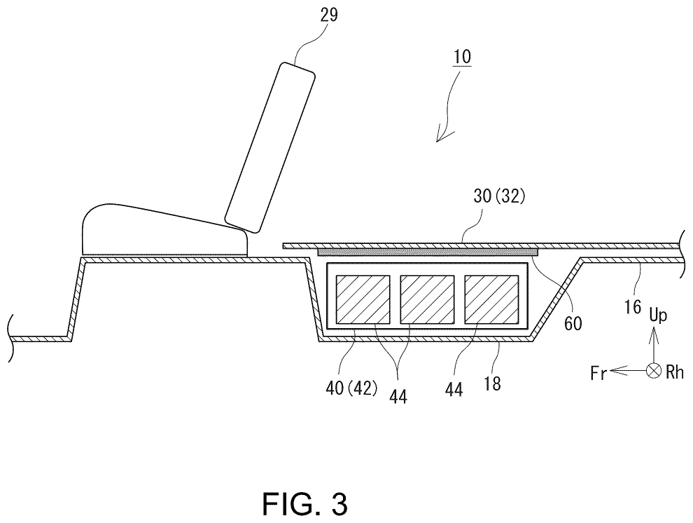

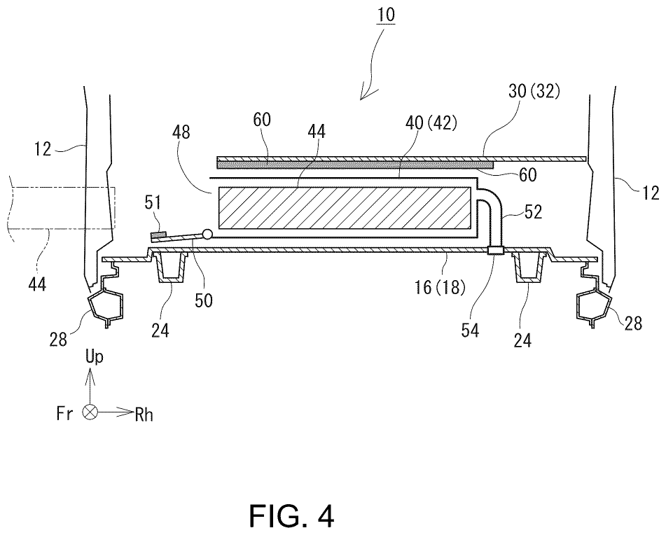

A structure of an electricity-driven vehicle 10 according to an embodiment of the present disclosure will now be described with reference to the drawings. FIG. 1 is a perspective diagram showing a region near a rear side door 12 of the electricity-driven vehicle 10, viewed from outside the vehicle. FIG. 2 is a schematic plan view of the electricity-driven vehicle 10. FIG. 3 is a cross-sectional diagram along an A-A line of FIG. 2, and FIG. 4 is a cross-sectional diagram along a B-B line of FIG. 2. In the drawings, “Fr”, “Up”, and “Rh” respectively refer to a front side, an upper side, and a right side of the electricity-driven vehicle 10.

The electricity-driven vehicle 10 comprises a traveling motor (not shown), and a battery 44 which supplies electric power to the traveling motor. The electricity-driven vehicle 10 exemplified below is a commercial vehicle for transporting baggage. A rear seat of the electricity-driven vehicle 10 is removed, in order to improve a loading efficiency of the baggage. Therefore, an entirety of a rear side of a front seat 29 (not shown in FIG. 1; refer to FIG. 3) can be used as a baggage compartment. On a side of the electricity-driven vehicle 10, a front side door 11 and a rear side door 12 are placed, aligned in a front-and-rear direction. As shown in FIG. 2, the front side door 11 is a hinge door which swings about an axis extending in a vertical direction, and the rear side door 12 is a sliding door which slides in a vehicle front-and-rear direction. The rear side door 12 opens and closes a rear side door opening 14.

The battery 44 is a replaceable battery which can be easily replaced in the electricity-driven vehicle 10. The battery 44 is formed by housing a battery body formed from a plurality of unit cells in a housing. The housing of the battery 44 has, for example, a parallelepiped shape elongated in a vehicle width direction. A battery-side connector is provided at an end of the battery 44. When the battery-side connector is connected to a vehicle-side connector, an electric power system equipped on the vehicle and the battery 44 are electrically connected with each other. The battery body is a secondary battery (for example, a lithium ion battery or the like) which can be charged and discharged. Therefore, the battery 44 which is removed from the electricity-driven vehicle 10 can be charged externally to the vehicle.

By setting the battery 44 as a replaceable battery in this manner, the usage efficiency of the electricity-driven vehicle 10 can be improved, and a demand peak of commercial electric power can be reduced. That is, when the battery 44 is of the replaceable type, after the battery 44 is removed from the electricity-driven vehicle 10, another battery 44 which is already charged can be mounted on the electricity-driven vehicle 10. Further, with such a configuration, because the electricity-driven vehicle 10 can travel even during a period in which a part of the battery 44 is charged, the usage efficiency of the electricity-driven vehicle 10 is improved. In addition, when the battery 44 is of the replaceable type, time of performing the charging operation can be freely selected, regardless of a usage situation of the electricity-driven vehicle 10. Because of this, the battery 44 can be charged during a time period of low demand of the commercial electric power (for example, late at night), and the demand peak of the commercial electric power can be reduced.

Such a battery 44 is mounted at a location where a user can easily replace the battery and where loading of the baggage is not obstructed. In the case of the electricity-driven vehicle 10 of the present disclosure, a battery loading portion 40 at which the battery 44 is loaded is provided at an adjacent position of the rear side door opening 14. The battery loading portion 40 will now be described in detail.

First, prior to the description of the battery loading portion 40, a basic vehicle body structure of the electricity-driven vehicle 10 will be described. The electricity-driven vehicle 10 has a vehicle body structure approximately identical to that of existing vehicles. By using the vehicle body structure of the existing vehicles as is, components and manufacturing processes can be made common with the existing vehicles, resulting in reduction of development and manufacturing costs of the electricity-driven vehicle 10. As shown in FIGS. 2 and 4, the electricity-driven vehicle 10 comprises a pair of side members 24 placed with a spacing in the vehicle width direction, and a plurality of cross members 26 connecting the pair of side members 24. Each of the side members 24 and the cross members 26 is a frame of the electricity-driven vehicle 10.

As shown in FIG. 4, at an upper side of the side member 24, a floor panel 16 is provided. The floor panel 16 is a steel plate panel forming a floor surface of a vehicle cabin. The floor panel 16 is welded to the frame (side member 24 or the like) of the electricity-driven vehicle 10. As shown in FIG. 3, at an immediately rear side of the front seat 29, a depressed portion 18 is present. The depressed portion 18 is a portion which extends in the vehicle width direction and which is depressed in a groove shape. In the case of the existing vehicles, a rear seat is placed at an immediately rear side of the depressed portion 18. As described above, in the case of the electricity-driven vehicle 10 of the present embodiment, the rear seat is removed.

At a laterally adjacent position of the depressed portion 18, the rear side door opening 14 is placed. As shown in FIG. 4, a lower end of the rear side door opening 14 is defined by a rocker 28. The rocker 28 is one type of a frame extending in the vehicle front-and-rear direction. In the present embodiment, as shown in FIG. 4, the battery loading portion 40 is provided in the depressed portion 18. In addition, as shown in FIG. 2, the battery loading portion 40 is completely fitted within a width of the rear side door opening 14 in the front-and-rear direction. By employing such a configuration, the user can easily access the battery loading portion 40 through the rear side door opening 14.

The battery loading portion 40 is a part at which the battery 44 is loaded. The battery loading portion 40 has a battery casing 42. As shown in FIG. 4, the battery casing 42 is a container which houses one or more batteries 44 (in the illustrated example configuration, three batteries 44), and is a box approximately having a parallelepiped shape with one end in the vehicle width direction opened. The opening of the battery casing 44 at one end in the vehicle width direction serves as a loading port 48 through which the battery 44 is inserted and removed. When the battery 44 is to be replaced, the user accesses the battery casing 42 from a side of the electricity-driven vehicle 10 (in the illustrated example configuration, the left side), and inserts or removes the battery 44 via the loading port 48. As described above, in the present embodiment, the rear side door 12 is the sliding door. By employing the sliding door, interference between the battery 44 to be inserted or removed and the rear side door 12 can be effectively prevented, and workability when the battery 44 is replaced can be improved.

The loading port 48 is opened and closed by a casing lid 50. The casing lid 50 airtightly covers the loading port 48. In order to maintain airtightness, for example, on at least one member of the casing lid 50 and the loading port 48, a sealing member 51 which airtightly contacts the other member is attached. By providing the airtightness to the casing lid 50 in this manner, it becomes possible to prevent inflow of the gas to be described later into the vehicle cabin. The handling of the gas will be described later.

In addition, in the case of the present embodiment, the casing lid 50 swings with the center near a lower end of the loading port 48. As shown in FIG. 4, the casing lid 50 closes the loading port 48 when in a standing orientation approximately parallel with a perpendicular surface. When the casing lid 50 in the standing orientation swings downward, the loading port 48 is opened. By swinging the casing lid 50 about the lower end of the loading port 48 in this manner, a configuration is achieved in which, when the casing lid 50 is opened, the casing lid 50 does not interpose between eyes of the user (which are normally positioned above the loading port 48) and the loading port 48. With this configuration, the user can more easily see the periphery of the loading port 48, and, as a consequence, the workability when the battery 44 is replaced can be improved. In addition, in the case of the illustrated example configuration, a dimension of the casing lid 50 in the up-and-down direction is significantly smaller than the dimension of the casing lid 50 in the front-and-rear direction. Thus, by employing a configuration where the casing lid 50 opens downward, as compared with a case where the casing lid 50 opens laterally, an amount of protrusion when the casing lid 50 is opened can be set small. However, the structure of the casing lid 50 is not limited to the illustrated example configuration, and may be suitably changed. For example, the casing lid 50 may be changed to a laterally opening type, a double door type, or a sliding type.

As shown in FIGS. 2 and 4, the battery loading portion 40 (that is, the battery casing 42) is fitted within a width between the two side members 24 in the plan view. With such a configuration, when the electricity-driven vehicle 10 collides at the side, the side member 24 receives the impact before the battery loading portion 40. Because of this, damage to the battery 44 housed in the battery loading portion 40 is effectively prevented.

As shown in FIG. 3, a height of the battery casing 42 is shorter than a depth of the depressed portion 18. The electricity-driven vehicle 10 further comprises a deck board 30 placed at an upper side of the floor panel 16 so as to cover and hide the depressed portion 18. In other words, the battery loading portion 40 is placed in a space surrounded by the deck board 30 and the depressed portion 18. As shown in FIGS. 2 and 3, the deck board 30 forms a flat floor surface, extending from a rear side of the front seat 29 to a rear end of the vehicle. By providing such a deck board 30, the entirety of the space behind the front seat 29 can be used as a baggage compartment, and thus, a transport efficiency of the baggage by the electricity-driven vehicle 10 can be improved.

The deck board 30 is not welded to any of the members of the electricity-driven vehicle 10, and can be removed from the electricity-driven vehicle 10 without destroying a component of the electricity-driven vehicle 10. By removing the deck board 30 from the electricity-driven vehicle 10 as necessary, maintenance or the like of the battery loading portion 40 can be easily performed.

As described above, a baggage or the like is placed at an upper side of the deck board 30. In the present embodiment, a thermal insulation member 60 is placed between the deck board 30 and the battery casing 42. The thermal insulation member 60 may be attached to the deck board 30, or attached to a top surface of the battery casing 42. Further, the thermal insulation member 60 may be a separate member, separated from both the deck board 30 and the battery casing 42.

In either case, by providing the thermal insulation member 60, transfer of heat of the battery 44 to an upper side of the deck board 30 (and consequently, the baggage) can be prevented. With this configuration, degradation of the baggage, and discomfort of the passengers due to an increase in the temperature can be suppressed.

Here, gas may be released from the battery 44 due to overcharging, overdischarging, short-circuiting, or the like. The replaceable battery 44 is configured such that the gas can be released to the outside of the battery 44. The gas has a high temperature, and in some cases, an odor. If such gas flows into the space at the upper side of the deck board 30, degradation of the baggage or discomfort of the passengers may result.

In consideration of this, in the present embodiment, a smoke exhaust duct 52 for guiding the gas to outside the vehicle is provided. As shown in FIG. 4, the smoke exhaust duct 52 is a duct which extends from an end surface of the battery casing 42 at a side opposite the loading port 48, penetrates through a bottom surface of the depressed portion 18, and is opened to the outside of the vehicle. The gas generated from the battery 44 is released to the outside of the vehicle via the smoke exhaust duct 52. In this manner, by releasing the gas to a lower side of the floor panel 16, inflow of the gas into the upper space of the deck board 30 can be effectively prevented.

A check valve 54 is attached to the smoke exhaust duct 52. The check valve 54 permits passage of a fluid from the battery casing 42 to the outside of the vehicle, but prohibits passage of the fluid from the outside of the vehicle to the battery casing 42. By providing the check valve 54, a back flow of the gas released to the outside of the vehicle into the battery casing 42 can be prevented.

Here, obviously, a through hole through which the smoke exhaust duct 52 is inserted is formed on the bottom surface of the depressed portion 18. In the example configuration of FIG. 4, the smoke exhaust duct 52 extends from the end surface of the battery casing 42 in the vehicle width direction, and the through hole of the depressed portion 18 is positioned at an outer side of the battery casing 42. With such a placement, when assembling the battery casing 42, the operator can easily view the position of the through hole of the depressed portion 18. As a result, the assembling operation of the battery casing 42 can be simplified.

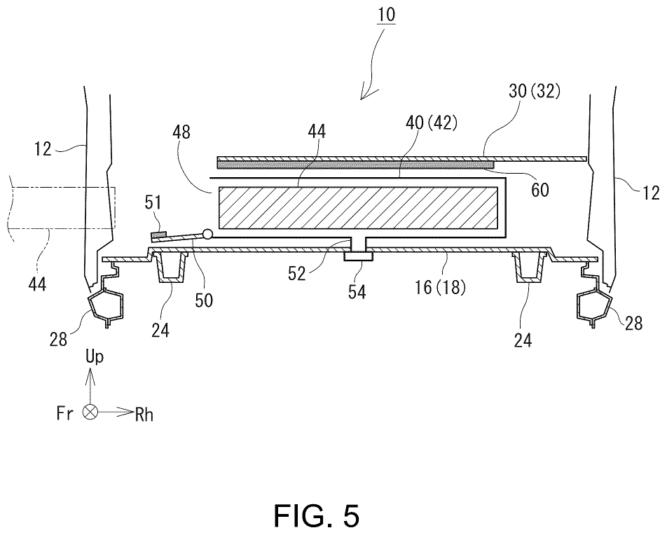

However, the placement of the smoke exhaust duct 52 is not limited to the example configuration of FIG. 4, and may be suitably changed. For example, as shown in FIG. 5, the smoke exhaust duct 52 may extend from a bottom surface of the battery casing 42. With such a configuration, a dimension of the battery casing 42 in the vehicle width direction can be increased as compared with the example configuration of FIG. 4.

In addition, as shown in FIG. 5, the smoke exhaust duct 52 may penetrate through the bottom surface of the depressed portion 18 approximately at the center in the vehicle width direction. With this configuration, an extent of a structural change of the electricity-driven vehicle 10 when left and right sides of the battery loading portion 40 are inverted can be reduced. Specifically, in FIG. 5, a configuration is employed in which the battery 44 is replaced from the left side of the electricity-driven vehicle 10. However, in some cases, depending on the user's desires, it may be desired to replace the battery 44 from the right side of the electricity-driven vehicle 10. In order to fulfill such desires of the user, the placement of the battery loading portion 40 may in some cases be inverted in the left and right sides, before the user purchases the electricity-driven vehicle 10. In the case of FIG. 4, if the placement of the battery loading portion 40 is inverted in regard to the left and right sides, the position of the through hole into which the smoke exhaust duct 52 is inserted significantly changes. On the other hand, if the smoke exhaust duct 52 is provided approximately at the center in the vehicle width direction as shown in FIG. 5, the position of the through hole does not change even when the placement of the battery loading portion 40 is inverted in the left and right sides. As a result, the extent of the structural change of the electricity-driven vehicle 10 due to the left-and-right inversion of the battery loading portion 40 can be set small.

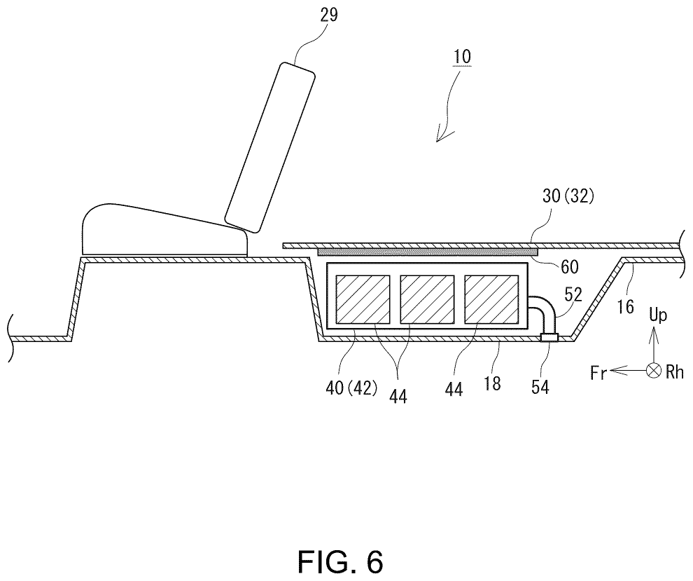

As another form, as shown in FIG. 6, the smoke exhaust duct 52 may extend from a rear end surface of the battery casing 42. With such a configuration, the front seat 29 (and consequently, the passengers) can be separated from the flow path of the gas. As a result, the flow of the gas to the periphery of the passengers can be more reliably prevented. In this case also, the smoke exhaust duct 52 may be placed approximately at the center in the vehicle width direction.

The structures described above are merely exemplary, and, so long as the electricity-driven vehicle has the structure described in claim 1, the other structures may be suitably changed. For example, in the above description, the rear side door 12 is described as a sliding door, but alternatively, the rear side door 12 may be a hinge door, similar to the front side door 11. Further, the structure of the battery loading portion 40 may also be suitably changed. For example, the shape and the size of the battery loading portion 40 may be suitably changed. Moreover, the number and placement of the smoke exhaust duct 52 may be suitably changed. For example, a plurality of the smoke exhaust ducts 52 may be provided.

### REFERENCE SIGNS LIST

10 electricity-driven vehicle, 11 front side door, 12 rear side door, 14 rear side door opening, 16 floor panel, 18 depressed portion, 24 side member, 26 cross member, 28 rocker, 29 front seat, 30 deck board, 40 battery loading portion, 42 battery casing, 44 battery, 48 loading port, 50 casing lid, 51 sealing member, 52 smoke exhaust duct, 54 check valve, 60 thermal insulation member

1. An electricity-driven vehicle comprising:
a floor panel;
a depressed portion of a groove shape, that is formed on the floor panel and that extends in a vehicle width direction;
a battery casing that is placed in the depressed portion;
one or more batteries of a replaceable type, that can be attached to and detached from the battery casing;
a smoke exhaust duct that extends from the battery casing, that penetrates through a bottom surface of the depressed portion, and that is opened to an outside of the vehicle; and
a check valve that is provided on the smoke exhaust duct, and that prohibits inflow of a fluid from the outside of the vehicle into the battery casing.

2. The electricity-driven vehicle according to claim 1, further comprising:
a deck board that covers and hides the depressed portion; and
a thermal insulation member placed between the deck board and the battery casing.

3. The electricity-driven vehicle according to claim 1, wherein
a loading port of the battery is formed at one end of the battery casing in the vehicle width direction, and
the smoke exhaust duct extends from an end surface of the battery casing at a side opposite the loading port.

4. The electricity-driven vehicle according to claim 1, wherein
the smoke exhaust duct penetrates through the bottom surface of the depressed portion approximately at a center in the vehicle width direction.

5. The electricity-driven vehicle according to claim 1, wherein
the smoke exhaust duct extends from a bottom surface or a vehicle-rear-end surface of the battery casing.
